(19) United States
(12) Patent Application Publication
(10) Pub. No.: US 2009/0166454 A1
(43) Pub. Date: Jul. 2, 2009

(54) METHOD OF DISPOSING CITY REFUSES

(75) Inventor: Li Wang, Beijing (CN)

Correspondence Address: YING CHEN;Chen Yoshimura LLP, 255 S. GRAND AVE., # 215, LOS ANGELES, CA, 90012, US

(73) Assignee: BEIJING HENGYECUN S&T CO., LTD., Beijing (CN)

(21) Appl. No.: 12/118,265

(22) Filed: May 9, 2008

(30) Foreign Application Priority Data
Dec. 29, 2007 (CN) 200710304736.8

(51) Int. Cl. B02C 23/14

(52) U.S. Cl. 241/24.14

(57) ABSTRACT

This invention relates to a method of disposing city refuses comprising following steps: (1) primary classification, in which the materials which can be independently disposed are separated from the city refuses; (2) first crushing; (3) first separating, in which the refuses is divided into two classes of heavy materials made of minerals mainly and slight materials made of organics mainly; (4) crushing of heavy materials; (5) magnetic separating of heavy materials, in which the heavy material is divided into two classes of magnetic heavy materials and non-magnetic heavy materials; and (6) crushing of slight materials. The method recycles most of the city refuses as reusable materials.

### BACKGROUND OF THE INVENTION

1. Field of the Invention

This invention relates to a method of disposing city refuses.

2. Description of the Related Art

Due to their complicated components, the city refuses are difficult to be disposed, especially for reusing of the refuses. At present, except for a small amount of refuses which can be directly recycled, most of the city refuses are disposed by burying or burning. However, shortcomings of such disposing methods cannot be ignored. For example, the burying will occupy a lot of lands and pollute underground water and air, the burning will consume a lot of energy and the flue gases also comprise harmful components which are also difficult to be disposed. The yield of city refuses is increased continuously with the development of urbanization and the burying and the burning of city refuses meet a great difficulty in dealing with source protection and environmental protection. Therefore, new methods are studied to utilize materials of city refuses as resources, of which one important aspect is the separate collecting and the separate disposing of refuses. A present separate collection manner is to classify refuses as recyclable refuses and non-recyclable refuses according to their nature. These two classes of refuses are respectively collected by putting them into different containers. The recyclable refuses are mainly the materials which can be directly reused as industrial materials such as plastic, metal and glass, while the non-recyclable refuses are mainly other materials which can not be directly used as industrial materials or have low reusing value. Although such respective collection has been generally accepted, it has a plurality of problems in actual implement, of which the first is that people tend to put refuses together in order to save time, the second is that the classification manner lists most of the city refuses into the non-recyclable class, which won't be of much help for reducing amount of refuses to be buried and burned.

### SUMMARY OF THE INVENTION

In order to overcome the shortcomings mentioned above, the invention provides a method of disposing city refuses. The method recycles most of the city refuses as reusable materials.

The technical solution of this invention to achieve above purposes is that: a method of disposing city refuses, mainly comprising the following steps:

(1) primary classification, in which the materials which can be independently disposed are separated from the city refuses;

(2) first crushing;

(3) first separating, in which the refuses is divided into two classes: heavy materials made of minerals mainly and light materials made of organics mainly;

(4) crushing of heavy materials;

(5) magnetic separating of heavy materials, in which the heavy material is divided into two classes: magnetic heavy materials and non-magnetic heavy materials; and

(6) crushing of light materials.

The benefit of the invention is that the materials are separated and treated into reusable materials with a simple process according to the general characters of city refuse materials. For example, the magnetic heavy material mainly contains metal materials, so that the magnetic heavy material can be used as metallurgy raw materials; the non-magnetic heavy material mainly contains inorganic mineral materials, so that the non-magnetic heavy materials can be used as construction raw materials or filling materials in particular occasions; and the slight material mainly contains organic materials, so that the slight material can be separated further according to the characters of the organics to be used as fuel and for producing natural gas. Based on this method, most of city refuses can be reused. In addition, the invention is adapted to the current condition of city refuses without increasing added load for people, thereby being beneficial for generalizing and using in practice.

### BRIEF DESCRIPTION OF THE DRAWING

FIG. 1 is a flow diagram of an embodiment of this invention.

### DETAILED DESCRIPTION OF THE PREFERRED EMBODIMENTS

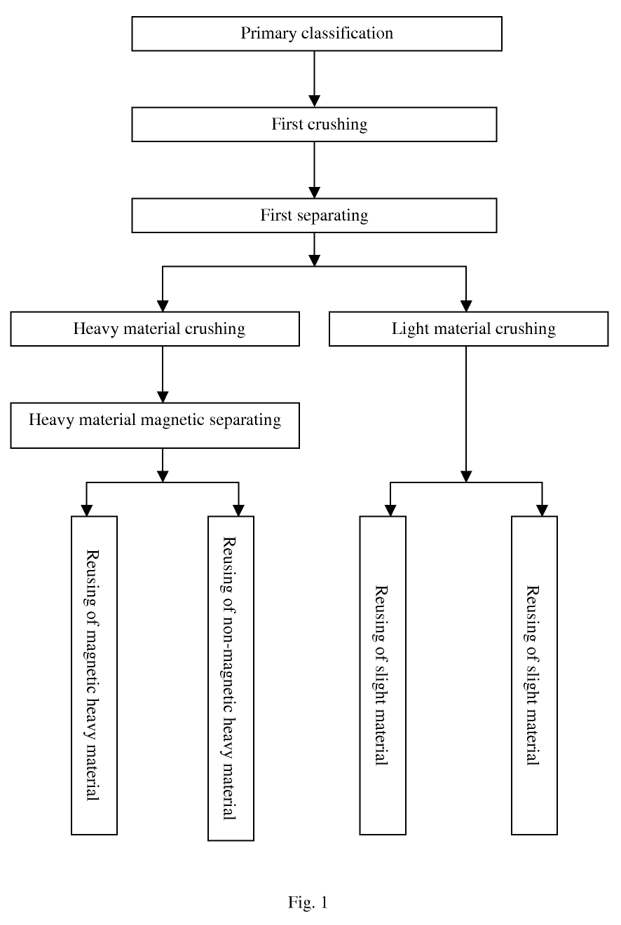

With reference to FIG. 1, this invention make different materials of city refuses recyclable by separating them according to their physical and chemical characters, mainly comprising the following steps:

(1) Primary Classification, in which the Materials which can be Independently Disposed are Separated from the City Refuses.

The primary classification begins with the collection of city refuses. The purpose of the primary classification is to separate from the city refuses the materials which can be more conveniently and more efficiently disposed independently or should not be mixed in the city refuses for further disposing in order to acquire a better disposing effect and to avoid hindrance on further disposing from certain particular materials.

The prior popularized separate collection of refuses is one means of the primary classification, in which different refuses are put into different refuses receptacles for separate collection and then transported and further disposed separately. The recyclable refuses are sent to a recycling site for recycling while the other refuses of the city refuses are mixed together for uniform disposing. The recyclable refuses are mainly materials which can be directly used as industrial materials such as plastic, metal, glass and fabric.

Some particular refuses can also be collected independently in event of large amount. Generally, the particular refuses are collected independently during the primary classification for disposing according to the particular components of the refuses. For example, the construction decorative refuses mainly contains a large amount of concretes, sands and stones which can be used as underground filling materials after being collected or used as building materials after being crushed, thereby avoiding mixing the particular refuses into the city refuses and being beneficial for saving the disposing expenses.

The other means of the primary classification is that the large amount or big materials which are mixed in the city refuses should be picked out. For example, the useful materials such as big metal, plastic, wood, rubber and fabric are picked out from the mixed refuses. The materials which are improper to be sent to the post-disposing device are also picked out from the mixed refuses. Currently, some picking devices have been available. However, most of the useful materials are still picked out manually.

What is worth noticing is that, as the refuses materials are recycled for using finally, a plurality of poisonous and harmful refuses or dangerous refuses such as radioactive refuses and infective refuses have to be disposed independently according to relevant regulations.

(2) First Crushing.

The proposal of the first crushing is to crush big materials into a proper size suitable for classification. The crushing is achieved through a jaw crusher which is of a large crushing rate and a simple structure. The materials crushed by a jaw crusher are of even sizes. In addition, the jaw crusher is suitable to be used for crushing materials such as city refuses with complicated components.

Considering the crushing cost and the crushing efficiency, the first crushing can also be divided into two steps, of which the first step is to crush big materials into small materials through the jaw crusher, the second step is to crush by a shock crusher and/or roller crusher. The shock crusher is suitable to crush middle hard, soft, fragile, tough and fiber type materials, while the roller crusher is suitable to crush materials with relatively high rigidity. The crushing devices should be chosen according to the particular nature of the refuses.

(3) First Separating.

The purpose of the first separating is to divide refuses materials into two classes of heavy materials made of minerals and slight material made of organics. The classification can be achieved through wind classification. The heavy materials are mainly made of minerals, while the slight materials are mainly made of organics.

(4) Crushing of Heavy Materials.

The purpose of the heavy material crushing is to reduce the sizes of the heavy materials to meet the requirements of the subsequent magnetic separating and recycling.

The heavy material crushing can be achieved through a ball mill to meet requirements of the subsequent magnetic separating.

(5) Magnetic Separating of Heavy Materials.

In this step, the heavy material is separated through a magnetic separating device into two classes of magnetic heavy materials and non-magnetic heavy materials.

Most of the magnetic heavy materials are of metallurgy value. The magnetic heavy materials can be used as mineral sands and be separated further according to prior metallurgy arts. The separated fine mineral sands can be used as metallurgy raw material and the separated tail mineral sands can be disposed independently as construction materials or mixed in the non-magnetic heavy materials. The non-magnetic heavy materials are mainly mineral materials which are of little metallurgy value and can be used as construction materials or filling materials, etc.

(6) Crushing of Slight Materials.

The crushing slight materials can be achieved through a roller crusher, a shock crusher or a cut type crusher. The size of crushing is decided according to the subsequent recycling manner. As such materials are mainly made of organics, it can be used as fuel and also can be used for producing natural gas, producing fertilizer and etc. after being crushed. The different components of slight materials can be further separated to use a proper recycling manner to treat them separately.

During the implementation of this invention, the materials can be transported and stored according prior arts.

As most of mineral materials in the city refuses have no hydraulicity and activity, a proper means should be chosen according to the nature of the mineral materials during recycling, especially when it is used as construction raw materials.

The primary classification can also be followed by a primary magnetic separating step so as to separate the iron materials from the city refuses, thereby not only being beneficial for the resource utilization, but also can prevent the city refuses which contains a relatively large amount of iron from damaging the post device. The primary magnetic separating can use a suspended sucking magnetic separator.

It will be apparent to those skilled in the art that various modification and variations can be made in the method of the present invention without departing from the spirit or scope of the invention. Thus, it is intended that the present invention cover modifications and variations that come within the scope of the appended claims and their equivalents.

What is claimed is:

1. A method of disposing city refuses, comprising:
(1) classifying the city refuses to separate out materials which can be independently disposed of;
(2) crushing the refuses;
(3) separating the crushed refuses into heavy materials containing metal materials and light materials containing organic materials;
(4) crushing the heavy materials;
(5) magnetically separating the heavy materials into magnetic heavy materials and non-magnetic heavy materials; and
(6) crushing the light materials.

2. A method of claim 1, wherein step (1) includes placing different refuses into different refuses receptacles for separate collection, the method further comprising sending recyclable refuses separated out during step (1) to a recycling site for recycling, and mixing remaining refuses mixed together for uniform disposing.

3. A method of claim 2, wherein step (1) includes independently disposing of poisonous and harmful refuses or dangerous refuses.

4. A method of claim 3, wherein the crushing of refuse is carried out using a jaw crusher in step (2).

5. A method of claim 3, wherein the crushing of refuse in step (2) includes a first step of crushing big materials into small materials using a jaw crusher, and a second step of crushing by a shock crusher and/or roller crusher.

6. A method of claim 4, wherein step (3) is carried out using wind classification means.

7. A method of claim 6, wherein step (4) is carried out using a ball mill.

8. A method of claim 7, wherein the magnetic heavy materials separated in step (5) are used as mineral sands, the non-magnetic heavy materials separated in step (5) are used as construction materials or filling materials.

9. A method of claim 8, wherein step (6) is carried out using a roller crusher, a shock crusher or a cut type crusher.

10. A method of claim 9, wherein the crushed light materials are used as fuel or for producing natural gas or fertilizer.

11. A method of claim 10, further comprising, after step (1), magnetically separating the refuses using a suspended sucking magnetic separator.

12. A method of claim 5, wherein step (3) is carried out using wind classification means.

13. A method of claim 12, wherein step (4) is carried out using a ball mill.

14. A method of claim 13, wherein the magnetic heavy materials separated in step (5) are used as mineral sands, the non-magnetic heavy materials separated in step (5) are used as construction materials or filling materials.

15. A method of claim 14, wherein step (6) is carried out using a roller crusher, a shock crusher or a cut type crusher.

16. A method of claim 15, wherein the crushed light materials are used as fuel or for producing natural gas or fertilizer.

17. A method of claim 16, further comprising, after step (1), magnetically separating the refuses using a suspended sucking magnetic separator.

18. A method of claim 1, further comprising, after step (1), magnetically separating the refuses using a suspended sucking magnetic separator.
